(19) United States
(12) Patent Application Publication
(10) Pub. No.: US 2012/0311633 A1
(43) Pub. Date: Dec. 6, 2012

(54) AUTOMATIC CLIP GENERATION ON SET TOP BOX

(76) Inventors: Ishan Mandrekar, Monmouth Junction, NJ (US); Jens Cahnbley, Princeton Junction, NJ (US); David Anthony Campana, Princeton, NJ (US); David Brian Anderson, Florence, NJ (US); Shemimon Manalikudy Anthru, Dayton, NJ (US)

(21) Appl. No.: 13/578,641

(22) PCT Filed: Feb. 11, 2011
(86) PCT No.: PCT/US11/00255

§ 371 Date: Aug. 13, 2012

Related U.S. Application Data
(60) Provisional application No. 61/306,216, filed on Feb. 19, 2010.

(51) Int. Cl. H04N 21/472; H04N 21/482; H04N 21/431

(52) U.S. Cl. 725/40; 725/53; 725/46

(57) ABSTRACT

A system and method of identifying and providing content to a user is described. The method is performed by a controller with an internet interface. A controller receives electronic program guide data, the electronic program guide data being selectively displayed on a primary display device. An attribute processor parses the received electronic program guide data to identify at least one program description attribute for a currently tuned program. A content processor searches the received electronic program guide and detects at least one further program having the identified at least one program description attribute. The content processor identifies the at least one further program as recommended content in step and a user interface generator generates, a user interface display including the recommended content user interface including a user selectable data item representing the recommended content for display on a secondary display device different from the primary display device.

### CROSS-REFERENCE TO RELATED APPLICATIONS

This application claims the benefit of U.S. Provisional Application Ser. No. 61/306,216 filed 19 Feb. 2010, and is hereby incorporated by reference in its entirety for all purposes.

### FIELD

The present arrangement provides a system and method that automatically searches and retrieves information from at least one source that is associated with content selected by a user.

### BACKGROUND

The number of available television channels has steadily increased over the years. In view of this increase, the average viewer is facing a glut of television content from which to choose. The average number of television channels that are received in a U.S. home has reached a record high of 118.6. The magnitude of available content combined with the busy lifestyle of the average viewer is bound to create instances where the viewer ends up missing programs of interest. Conventional solutions have been developed in an attempt to address this problem.

One solution to address this problem includes devices that employ time shifting of content such as a VCR, a Personal Video Recorder (PVR) and/or a Digital Video Recorder (DVR). These devices enable a user to access content of interest at a time other than when the original content is being broadcasted. Time shifting of content is provided by scheduling recordings of content of interest to be stored on a storage medium or in a memory. Additionally, as systems have advanced, PVRs/DVRs allow a user to schedule recordings by time, by specific program, by programming season etc. The systems utilize the program guide to allow the device to factor in re-runs, last minute schedule changes, changes in broadcast time, etc. Furthermore, these devices now include more than one independently operating tuner within the same receiver. Multiple tuners enable a user to record a live program while watching another live program simultaneously or to record two programs at the same time while watching a previously recorded one. Some dual-tuner DVRs also have the ability to output to two separate television sets at the same time. Moreover, these devices allow users to remotely program their DVR via an internet enabled device.

Another solution that has been developed is the implementation of Video on Demand (VoD) services which offer a different type of time shifting as compared to the recording devices discussed above. VoD services offered by cable providers typically work by hosting content on their backend servers and offering viewers a way to browse through and select a particular piece of content on their own television sets. The content is then streamed directly to their set-top boxes. With the improvement in compression and streaming technology in conjunction with the increasing bandwidth capacities of communication networks, websites such as HULU® and FANCAST® offer time and place shifting of television programs. A user can stream programs available on these sites, at any time and to any internet enabled device.

A drawback associated with time shifting devices and schemes is that these solutions require the user to be cognizant of what he/she will be missing or has already missed. However, being aware of all content that may be of interest to a user is increasingly difficult in view of the vast library of content available to users. Another drawback is that these solutions are unable to operate without the manual request and intervention of the user. The user needs to be aware of his likes/dislikes and then actively seek that content via any of the above mentioned services. This becomes increasingly difficult as the content space continues to expand. The above mentioned services require the user to actively pull content from them which is orthogonal to the push model typically associated with the consumption of TV content. Therefore, there is a need for a system that suggests content that may be desirable to a user without requiring user intervention to obtain the suggested content.

### SUMMARY

In a multi-screen home environment, the combination of set-top box (STB) and television (STB+TV) may be referred to as a primary display device that can function to record live content and organizes it as clips. When the presence of a secondary device is detected, a list of pre-recorded clips is presented on the secondary display device. The user now has the option of either watching the content on the primary display device or on the secondary display device or storing the content as content-on-the-go for later viewing on the second screen.

In one embodiment, a method of identifying and providing content to a user, the method performed by a controller with an internet interface. The method includes the activities of receiving, by the controller, electronic program guide data, the electronic program guide data being selectively displayed on a primary display device. The method further includes parsing, by an attribute processor, the received electronic program guide data to identify at least one program description attribute for a currently tuned program. The received electronic program guide is searched by a content processor which also detects at least one further program having the identified at least one program description attribute. The content processor also identifies the at least one further program as recommended content. The method further includes the activity of generating, by a user interface generator, a user interface display including the recommended content user interface including a user selectable data item representing the recommended content for display on a secondary display device different from the primary display device.

In another embodiment, a system for identifying and providing content to a user is described. The method is performed by a controller with an internet interface. A controller receives electronic program guide data, the electronic program guide data being selectively displayed on a primary display device. An attribute processor parses the received electronic program guide data to identify at least one program description attribute for a currently tuned program. A content processor searches the received electronic program guide and detects at least one further program having the identified at least one program description attribute. The content processor identifies the at least one further program as recommended content in step and a user interface generator generates, a recommended content user interface including a user selectable data item representing the recommended content for display on a secondary display device different from the primary display device.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a block diagram of a system in accordance with an aspect of an embodiment;

FIG. 2 is a diagram of a user interface of pushed information in accordance with an aspect of an embodiment;

FIG. 3 is an example of a content recommendation algorithm in accordance with an aspect of an embodiment;

FIG. 4 is another example of a content recommendation algorithm in accordance with an aspect of an embodiment;

FIG. 5 is a block diagram of a system in accordance with an aspect of an embodiment; and

FIG. 6 is an exemplary flow diagram detailing operation of the system in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware or a combination of hardware and software in execution. For example, a component can be, but is not limited to being, a process running on a processor, a processor, an object, an executable running on a processor, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

It should be noted that any hyperlinks used herein are used for purposes of example only. These hyperlinks may or may not be active and may or may not contain data. Any data stored at the location corresponding to any hyperlink is not required for an understanding of the present invention.

Content providers provide access to different types of content to a plurality of users. For example, cable/satellite providers typically rent set top boxes to consumers which act as a portal or gateway for the delivery of different types of content. The equipment that selectively provides access to content advantageously accesses content guide data that can be decoded and displayed to a user on a display device. Content guide data includes a listing of at least one channel on which content may be accessed and information associated with the content on the at least one channel. An example is electronic program guide (EPG) data that is delivered either directly inbound from the cable provider through the same channel as the broadcast data or through an added internet service that compiles and provides content guide data.

As noted above, the amount of content that is accessible by a user is increasing exponentially with the improvement in communication technology and infrastructure. The system described herein advantageously provides an automatic recommendation regarding content that may be interesting to at least one user at a location where content may be accessed. In one embodiment, the system automatically uses user-specific data in a user profile that includes content characteristic data (e.g. likes, dislikes, content genres, actors, etc) to automatically search for content that corresponds to at least one content characteristic data in the user profile. Once located, the system automatically acquires data representing at least a portion of the entire content to be provided to the user as a recommendation. The acquired recommended content may be automatically provided to (e.g. “pushed”) the at least one user on at least one of a primary display device and a secondary display device.

In another embodiment, the system advantageously identifies content that the user may have at least one of (a) previously accessed; (b) scheduled a recording; (c) performed a search to find; and (d) indicated via user input that the content is of interest. The system automatically searches content information sources (e.g. EPG data or any other external data source) that include information associated with the interesting content. The system automatically parses the information to identify attributes associated with a respective program that provide particular types of information about the program and populates a database with the identified attributes. The identified attributes may be used as seed terms for a searching algorithm that automatically searches locations on a communication network for information that is related to the program.

The present system advantageously searches for and acquires related recommended content information from a plurality of different external sources for use in producing a user interface display image that provides recommended content to a user. The search and acquisition of related content information may be done in advance of when the user would be viewing the content and the recommendations may be automatically pushed to the user when the system identifies that the user is connected (e.g. the user is located within a predetermined area of a set top box). The results of these searches are automatically formatted into a user interface and presented to a user on at least one of a primary or secondary display device.

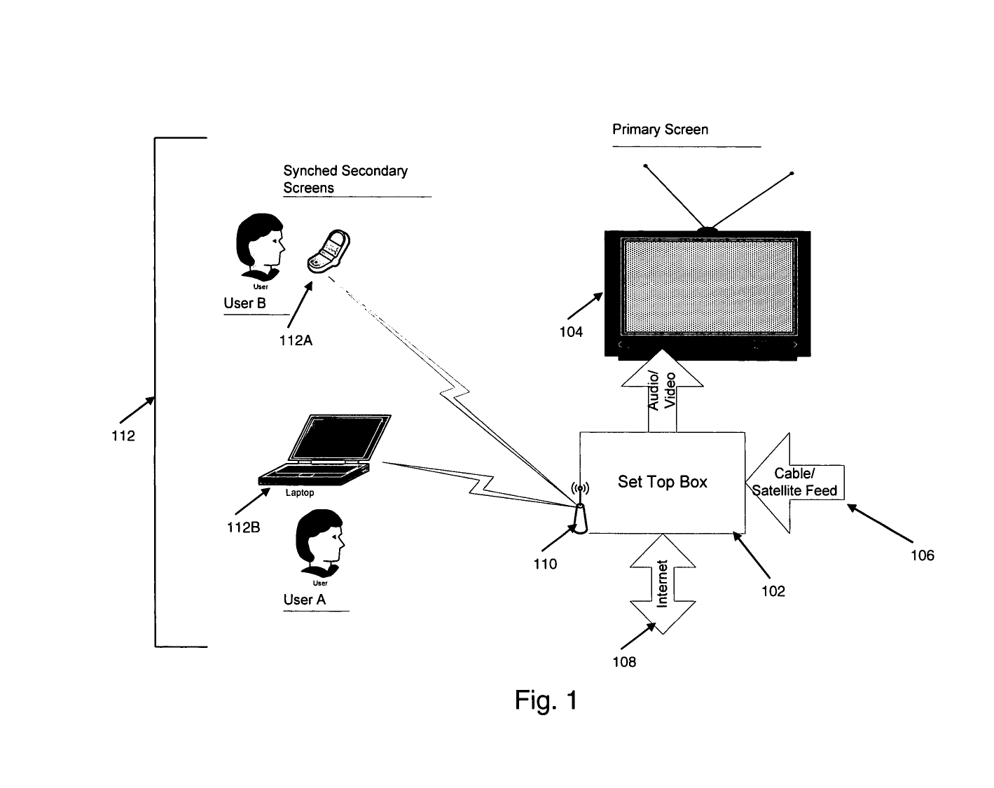

The system further provides techniques that leverage, for example, the primary display device (e.g., STB+TV) as the media hub in a multi screen interactive home setup (see FIG. 1). The system may automatically push recommended content to at least one of the primary display device and a secondary display device (e.g. smartphone, laptop, etc) as various programs are watched on TV. In this manner, the STB can build personalized TV viewing profiles for each member of the household that may be used to automatically initiate acquisition and recording of data representing recommended content. The content may be in the form of a video clip that may be at least one of a full or partial video and audio representation of live or pre-recorded content. The recommended content data may then be pushed to the user's second screen, giving him the option of watching the content on the primary display device, watching the content on the second screen or downloading the content for later viewing on either the primary or secondary display device.

One exemplary embodiment of the system is shown in FIG. 1 which includes a set top box 102, for example a cable television set top box, including a tuner module that selectively tunes an input signal from a cable/satellite provider 106. Additionally, set top box 102 may be internet ready and be able to receive and/or tune an input signal from an internet service or content provider available via the internet 108.

In the system embodiment 100 of FIG. 1, the set top box 102 is coupled to a primary display device 104, for example a high definition television monitor, which selectively displays content corresponding to the signal tuned by the tuner module in the set top box 102. While a set top box 102 is described as the access point enabling selection and viewing of content, it should be noted that any device including at least one tuner module enabling selection of content to be accessed may be used to implement the present system. Alternatively, the system may be implemented by any device that allows any piece of content to be selected and provided to a user in any manner. A secondary display device 112 may be provided for display of additional content in the form of recommended content. The secondary display device 112 may be any computing device that has access to at least one of a local area network and wide area network and which can access and receive data representing the enhanced content from the set top box 102 for display thereon. Secondary display device 112 includes but is not limited to, a computer, a laptop, a notebook, a tablet computer, a cellular phone, a smart phone or a second monitor different from the primary display device 104. As shown in FIG. 1, secondary display device 112A is a smartphone and secondary display device 112B is a laptop computer. While two types of secondary display devices 112A and 112B are shown, the system enables the connection of any number and type of secondary display devices to the set top box 102.

The secondary display devices 112 are able to communicate with the set top box 102 via a transceiver 110. The secondary display devices may communicate with the set top box 102 via wireless communication and/or wired communication. Examples of communication modes that may be supported and implemented by the set top box 102 include but are not limited to (a) wifi; (b) Bluetooth; (c) radio frequency; and (d) Ethernet. However, any communication scheme that enables data to be transmitted and received between the set top box 102 and any secondary device 112 may be used. The system advantageously distinguishes between the plurality of secondary display devices 112 connected to the set top box 102 by actively monitoring a device specific identifier that is unique to each secondary display device 112. An example of a device specific identifier may be a Media Access Control (MAC) address. However, this is described for purposes of example only and any data in any format may be used as a device specific identifier provided that the data uniquely identifies the particular device and allows it to be distinguished from any other device of the same type or different type.

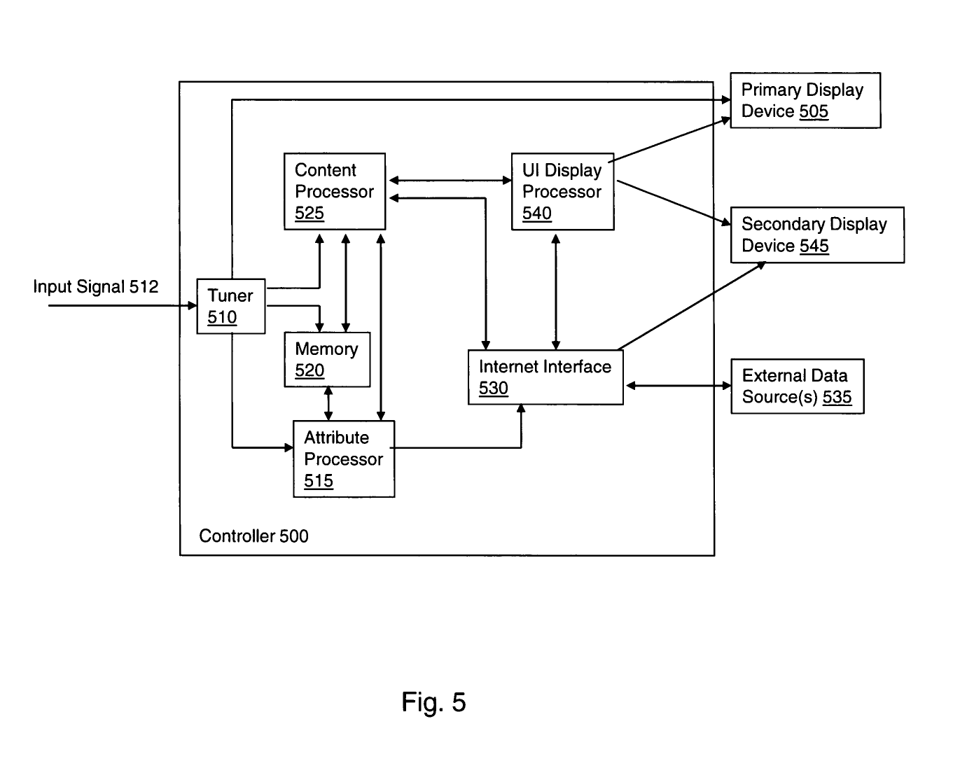

In one embodiment, the set top box 102 includes a memory (FIG. 5) that stores data representing a plurality of unique user profiles corresponding to users of secondary display devices that are able to access the set top box 102. For example, if the set top box 102 is located in a home having four people, each with a secondary display device, the set top box 102 may store four user profiles corresponding to each secondary display device 112. The user profile data may include a set of primary profile data items that may include any type of information that identifies and/or describes the user of the secondary display device including but not limited to (a) user demographic data; (b) data identifying types of content that are preferred by the user; (c) data identifying types of content avoided by the user; (d) data identifying sources from which content may be accessed; (e) data identifying a level of access for a particular content source available to the user; and (f) any type of data identifying the content accessing habits of the user. The primary profile data items may be user-specific and directly input into a user interface generated by the set top box 102. Alternatively, the primary profile data items may be communicated in a message format from the respective secondary display device 112 of the user. In another embodiment, primary profile data items may be derived from a source of user information such as a social networking profile page that includes information about the user.

Additionally, the user profile data stored in memory of the set top box includes user activity profile data items that are dynamically updated and based on the type of content that is accessed by the user. Set top box 102 may automatically track content that is tuned and displayed on primary display device 104. In one embodiment, the system automatically parses content description information (e.g. electronic program guide data) to derive content data corresponding to at least content attribute that describes the content. The parsing may occur if the content remains tuned for a predetermined period of time. In another embodiment, the system may automatically track user navigation of electronic program guide to identify content in which the user has interest. If the system determines that the guide navigation tool remains on a particular piece of content for a predetermined period of time (e.g. highlighting of an entry in the EPG), the system automatically parses content description information (e.g. electronic program guide data) to derive attributes describing the content and automatically add the content data to the user activity profile data. Alternatively, the system may automatically parse content description information (e.g. electronic program guide data) to derive attributes describing the content in response to a control signal requesting additional information about the content (e.g. selection of an “information button” on a remote control). Content data may be automatically added to the user activity profile data whereby these attributes can be used to search for and acquire content which will be presented to a user as recommended content data.

In these embodiments, the system advantageously makes content recommendations to users of the secondary devices without requiring direct input from the user. The recommendation algorithm gradually builds up a personal user profile of data by monitoring the content being accessed without having to solicit explicit feedback about the likes and dislikes of the user. The secondary display devices enable the system to push recommendations to the user in a non intrusive fashion. In another embodiment, the set top box 102 may be able to access user activity on the secondary display device (e.g. browsing history, social networking site information, other sources of user-specific information) to further refine the recommendation system by including this data in the user profile stored in set top box 102. This advantageously enables the system to make targeted recommendations of content that the user will be more likely to consume. For example, the viewing frequency of a particular user can be an input factor into an algorithm to improve the content being recommended to the user. If User A has a substantial amount of content pushed to them but the system determines that User A only watches the content infrequently (e.g. once a month), the system may automatically modify the manner in which the content is provided to User A by transcoding recommended content in a data format that allows the secondary device to acquire and store all recommended content data between viewings. Along the same lines, if User B has few pieces of content pushed to them but accesses the pushed content daily, the system may automatically modify the delivery manner by transcoding the recommended content in a higher resolution because it is accessed and deleted more frequently. Other modifications may be possible based on the viewing patterns and the content being viewed. The system automatically updates the user profile data with any data item that defines how recommendations should be made and how recommended content may be delivered to the secondary device.

The above described updating of data in a user activity profile may be performed by an attribute processor (FIG. 4) of the set top box 102. The attribute processor parses received program data, including program guide data, and populates a database executing on the set top box 102 with content description data corresponding to program attributes associated with respective programs available to be tuned by the tuner module. In alternate embodiments, the database may be located outside of the set top box 102 such as on a separate disc drive or at a cloud database storage location. An example of a set of attributes for each program includes, but is not limited to:
Title;
Subtitle;
Description;
Synopsis (generally implies a longer description);
Cast (actors, presenters, directors, narrators, producers);
Images (screen shots, posters, box art, thumbnail);
Genre/category;
Ratings and Advisories (e.g., PG-13);
Reviews and Star Ratings;
Other episodes of the same program;
Online sources of information (the show/episode on HULU®, FANCAST®, NETFLIX® . . . );
Related movies and shows;
Date of original airing;
Series data; and
Data describing topics/situations depicted in the program.

The attribute processor (FIG. 5) parses the program information to identify data corresponding to these attributes and automatically adds content description data to the user activity profile. The content data may be used by a search module executing on a content processor (FIG. 5) to search for and acquire interesting content to be presented to the user as recommended content data on the secondary display device 112.

The set top box 102 further includes a user interface (UI) display processor (FIG. 5) for selectively displaying a user interface including data representing recommended content that is acquired and pushed to the user based on the device-specific user profile data. Thus, the system automatically detects and differentiates between a plurality of different secondary display devices 112 that are within a predetermined range of set top box 102 in order to customize a set of recommended content data to be provided to each user based on the data in their respective user profile. In one embodiment, the secondary display device 112 may be detected implicitly via a device discovery service like Universal Plug N Play (UPnP)'s Simple Service Discovery Protocol (SSDP). A secondary display device 112 may act as a UPnP control point which allows it to search for devices of interest on, for example, a home network. The fundamental exchange in this process is a discovery message, containing among other things the unique device identifier (e.g. MAC address). The unique device identifier enables the set-top box 102 to differentiate between different secondary display devices 112 and ensure that the correct user profile data is used to acquire recommended content for the respective user. In another embodiment, the presence of the secondary device is announced explicitly by pointing the browser on the secondary device to a web server executing on the set-top box 102. For a browser initiated contact, the web server running on the set top box 102 has access to the User-Agent information (RFC 1945) stored in the HTTP Request header. The User-Agent request-header field contains information about the user agent originating the request. This is for statistical purposes, the tracing of protocol violations, and automated recognition of user agents for the sake of tailoring responses to avoid particular user agent limitations. The server can additionally set a one-time cookie inside the browser which can be subsequently retrieved to uniquely identify a particular device/user. Thus, the set top box 102 is always cognizant of who is watching what content and when in order to build the personalized user profile for each user based on what they typically watch on TV.

The following is an exemplary description of how recommended content data is caused to be pushed and displayed on the secondary display device 112. The following includes a description of television shows and content associated with the television show. However, one skilled in the art would appreciate that the system is operable to search for any television show, either broadcast live or stored on a storage medium, and acquire a set of related content data associated therewith to be provided in a UI display on the secondary display device 112.

This exemplary embodiment will be described with respect to User A with secondary device 112B shown in FIG. 1. However, one skilled in the art will appreciate that the operation may also simultaneously occur with respect to User B having secondary device 112A and provide recommended content to User B that is at least one of (a) the same as the recommended content provided to User A; (b) entirely different than the content provided to User A; and (c) at least partially the same as the content provided to User A. Moreover, this operation occurs for any number of users having a secondary display device 112 able to connect to the set top box 102.

In response to the creation of a user profile for User A, the content processor (FIG. 5) of the STB controller executes a content search module on set top box 102 that queries the electronic service guide received from at least one of a cable/satellite input signal 106 or a source of program guide data on the Internet 108. The content search module may be a set of machine executable instructions including an algorithm for searching for content to be presented to the user as recommended content. The content search module searches for and compares attribute data associated with at least one program in the program guide with attribute data values in the user profile data associated with the particular secondary display device 112. In response to determining that a predetermined number of attribute data values associated with the program in the EPG match the device-specific user profile data values, the content processor automatically identifies the program as interesting content and proceeds to recommend the interesting content to User A. Content processor automatically initiates a recording of the interesting content if the content is available at the current time. Alternatively, the content search module may execute in advance of the present time to search for interesting content and schedule recordings of future interesting content data which can then be provided to User A as recommended content data. Whether the recommended content data has already been recorded or is scheduled to be recorded, the content processor provides a list of data items corresponding to the recommended content to the UI display processor to generate a UI display image including the recommended content data items for display in the secondary display device 112B, for example, as a web page enabling the user to selectively access the related content. In response to a control signal received from a secondary display device 112 indicating that the user wishes to view a particular piece of recommended content, set top box 102 automatically causes the recommended content data to be displayed on the primary display device 104. In another embodiment, set top box 102 may automatically cause the recommended content data to be displayed on the secondary display device 112. In a further embodiment, set top box 102 may automatically transmit data representing the recommended content for receipt by and storage in a memory of the secondary display device 112 enabling later viewing of the recommended content.

In another embodiment, the set top box 102 may be controlled by a user 106 or other device (e.g. a VCR, a DVR, another tuner, etc) in a known manner, for example using a remote control (not shown), to cause the set top box 102 (or primary display device 104) to tune a desired program. In response to tuning a desired program, the content processor (FIG. 5) automatically parses electronic program guide data to identify content attributes associated with the currently tuned program. Attribute data associated with the currently tuned program may be used as seed terms for the content search module executing on the set top box 102. The content search module uses the derived attribute data to search current and future program listings to identify content that is similar to the currently tuned content in order to provide recommendations in the form of recommended content data. In response to locating content that includes a number of attribute data values in common with those associated with the currently tuned program, the content processor automatically initiates recording of the content in the event that the content is currently available or schedules a recording if the content is available at a later date. Data items identifying recommended content may be provided in a user interface on the secondary display device 112. In this embodiment, the search is actively performed during content viewing and recommendations may be automatically provided to the secondary display devices 112 of all users in a given range of the set top box 102.

In a further embodiment, the set top box 102 may controlled by a user 106 or other device (e.g. a VCR, a DVR, another tuner, etc) in a known manner, for example using a remote control (not shown), to cause the set top box 102 (or primary display device 104) to display a user interface including an electronic program guide on primary display device 104. The program guide data includes information that describes the plurality of programs that are available to be tuned at a give time. In creating a set of recommended content for display on the secondary display device 112, program guide data and any other data identifying and/or describing program content are parsed by the system to retrieve attribute data therefrom. The attribute data is derived by parsing the EPG data as a user selects a particular program within the EPG being displayed. It is important to note that this selection does not necessarily mean that the program is being tuned by the tuner module, but rather that the data in the EPG is highlighted or otherwise designated as active to be shown to the user on the primary display device. Thus, selection of a program within the EPG functions as a program identifier which identifies a respective program that is of interest to the user. The system uses the program identifier to retrieve attribute data for the selected program which may be used in searching EPG data for additional content that may be of interest to the user based on the attributes associated with the currently selected program. Moreover, in response to receipt of a control signal that causes the current program selection to change (i.e. scrolling through the guide), the system automatically searches for additional interesting content based on the attributes associated with the newly selected program. This advantageously provides the most complete set of recommended content to a user at any given time based on their content viewing habits.

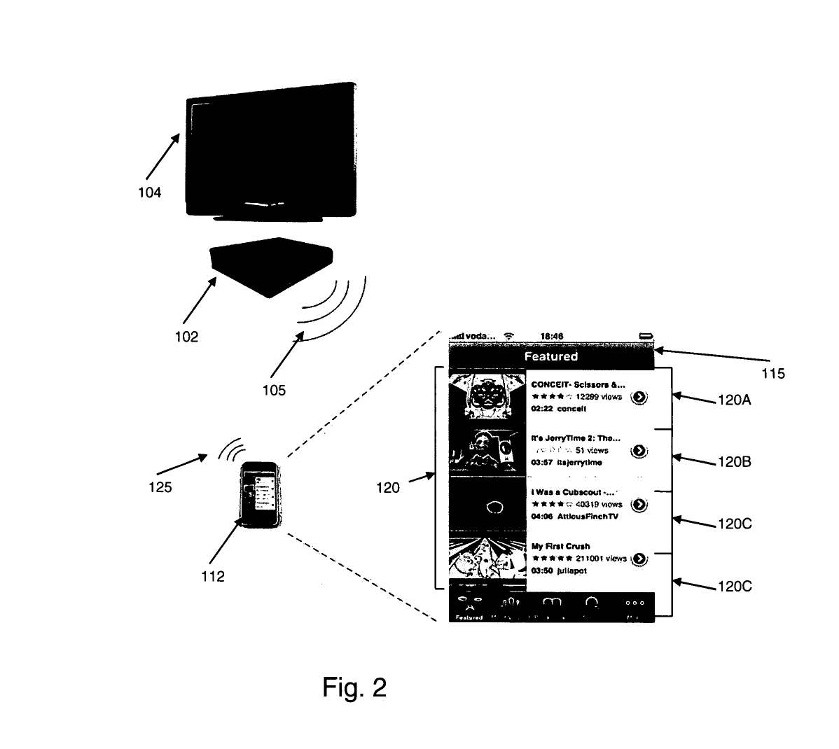

An exemplary user interface generated by the system enabling a user to review and select recommended content is shown in FIG. 2. FIG. 2 depicts the set top box 102 coupled to the primary display device 104. In response to a recommended content search performed by an embodiment of the content search module executing on the content processor as described in FIG. 1, data representing the recommended content is automatically formatted by a user interface display processor (FIG. 5) for display on a secondary display device 112. Data representing the formatted user interface is transmitted from set top box 102 to secondary display device 112 in signal 105. Upon receipt of the signal 105, secondary display device is caused to display the user interface including the recommended content on screen 115. Screen 115 of secondary display device 112 includes a recommended content region 120 that lists at least a partial set of data items 120A-D corresponding to recommended content that was located during the recommended content search. The data items displayed may include at least one of (a) data representing the recommended content in its entirety; (b) data representing a portion of the recommended content (e.g. a clip of a predetermined length of time) and (c) a link identifying a location at which the recommended content is stored. The user may select a respective data item 120A-D from within recommended content region 120 to initiate viewing of the particular recommended content data. Upon selection thereof, a request signal 125 is generated including data identifying the selected recommended content and transmitted by the secondary display device 112 for receipt by set top box 102. In response to receiving the request signal from secondary display device 112, the system automatically causes the recommended content data to be displayed on primary display device 104. In one embodiment, upon initiating display of the selected recommended content, the system may automatically record any content that is currently tuned by the tuner module of the set top box 102.

In another embodiment, the recommended content data items 120A-D may include a user selectable image element that enables the user to specify if the particular recommended content is interesting to the user. By indicating that recommended content is interesting or not interesting, a profile update signal is generated by the secondary display device 112 for transmission to the set top box. In response to receipt of the profile update signal, the system automatically updates user profile data to indicate that a particular recommendation was desired or non-desired. In this manner, the user is able to selectively approve or disapprove of recommended content and improve the recommendation algorithm implemented by the system. In one exemplary embodiment, the user profile data may be updated when a user identifies related content as not desirable by identify attributes of the not desirable content that differ from the attributes used as seed terms that located the content. Over time, content identified as not desirable includes similar non-matching attributes, the system may automatically modify the search algorithm to search for content having a certain set of attributes but not others. This modification is described for purposes of example only and any other modification that enables the system to dynamically update the user profile data to improve recommendations may be implemented.

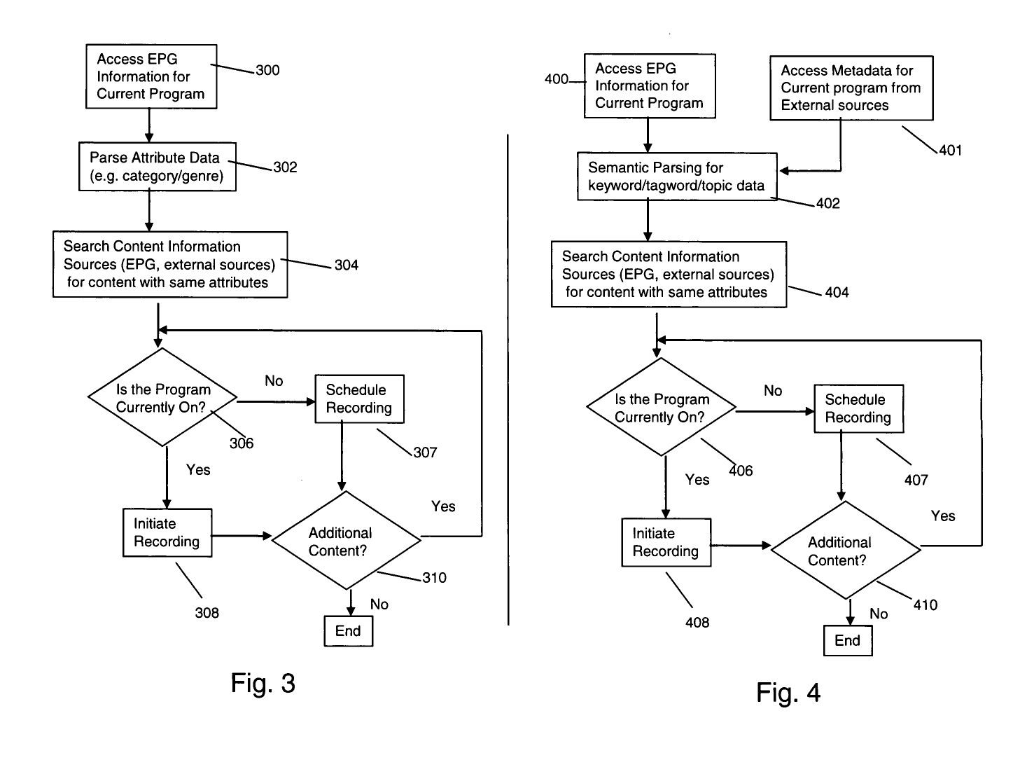

FIG. 3 is an exemplary recommendation algorithm implemented by a content processor (FIG. 5) in set top box 102 (FIG. 1). In this embodiment, the system searches for and acquires recommended content based on the currently tuned content. In step 300, electronic program guide information associated with the currently tuned content is accessed. The electronic program guide information is parsed, in step 302, to identify at least one type of attribute data that describes the currently tuned content. Data corresponding to the identified at least one type of attribute is used by the system to automatically search content information sources (e.g. electronic program guide data) for other content with the same attribute data in step 304. In another embodiment, the search in step 304 may include an internet search of external content information websites such as The Internet Movie Database, Wikipedia, NETFLIX®, etc for content that includes the same or similar attribute data in order to provide recommendations to additional content. For example, attribute data may include category information and genre information and the system will automatically search the EPG or other external content information sources to identify content having the same or similar attributes in order to identify content to be presented as recommended content. For each program identified in the search of step 304, the system in step 306 determines if the content is currently available for viewing. If the content is currently available then the system automatically initiates a recording of the identified content in step 308. If the determination in step 306 identifies that the content is not currently available, then the system automatically schedules a future recording in step 307. Operation continues from either steps 308 or 307 in step 310 whereby the system identifies if there is additional content available from the search step 304. If additional related content is present, the system repeats steps 306-310 as necessary until the determination in step 310 indicates that no additional recommended content data based on the currently tuned content is present.

FIG. 4 is another exemplary recommendation algorithm implemented by a content processor (FIG. 5) in set top, box 102 (FIG. 1). In this embodiment, the system searches for and acquires recommended content based on the currently tuned content. In step 400, electronic program guide information associated with the currently tuned content is accessed. At the same time, the system accesses metadata associated with the currently tuned program in step 401. The metadata accessed by the system may be derived from external content information sources such as program or provider-specific websites and/or databases that include additional information describing the currently tuned content. The metadata may assist the system in determining content that may be related to the currently tuned program that will qualify as recommended content to be presented to the user. The electronic program guide information is parsed in step 402 using metadata derived in step 401, to identify at least one type of attribute data that describes the currently tuned content. Data corresponding to the identified at least one type of attribute is used by the system to automatically search content information sources (e.g. electronic program guide data) for other content with the same attribute data in step 404. In another embodiment, the search in step 404 may include an internet search of external content information websites such as The Internet Movie Database, Wikipedia, NETFLIX®, etc for content that includes the same or similar attribute data in order to provide recommendations to additional content. For example, attribute data may include category information and genre information and the system will automatically search the EPG or other external content information sources to identify content having the same or similar attributes in order to identify content to be presented as recommended content. For each program identified in the search of step 404, the system in step 406 determines if the content is currently available for viewing. If the content is currently available then the system automatically initiates a recording of the identified content in step 408. If the determination in step 406 identifies that the content is not currently available, then the system automatically schedules a future recording in step 407. Operation continues from either steps 408 or 407 in step 410 whereby the system identifies if there is additional content available from the search step 404. If additional related content is present, the system repeats steps 406-410 as necessary until the determination in step 410 indicates that no additional recommended content data based on the currently tuned content is present.

The recommendation algorithm described in either of FIGS. 3 and 4 may also be implemented without the content being currently tuned. In one embodiment, the recommendation algorithm may be automatically executed when the system is displaying electronic program guide data on a primary display device and the user is navigating the electronic program guide data. In this embodiment, a program is selected but not necessarily tuned, when the navigation bar highlights a listing in the electronic program guide. Thus, the selected program may be used as the starting point of the algorithm and any navigation commands resulting in further content selection in the electronic program guide may re-initiate the recommendation algorithm accordingly. Additionally, in this embodiment, the system may search and access metadata as described in step 401 of FIG. 4 to improve the parsing of electronic program guide data to identify recommended content to be presented to the user. In another embodiment, the recommendation algorithm may automatically parse user profile data to identify attributes that the user has indicated as desirable. Using the set of desirable attributes derived from the dynamically created user profile data, the system is advantageously able to search the EPG for any content that includes attributes that match at least a subset of desirable attributes thereby identifying that the content should be recommended to the user. Additionally, in this embodiment, the system may search and access metadata as described in step 401 of FIG. 4 to improve the parsing of the electronic program guide data to identify recommended content to be presented to the user.

Further, in another embodiment, steps 304 in FIGS. 3 and 404 in FIG. 4 respectively may include searching external content provider sources in addition to the electronic program guide for content that may be presented as recommended content. In this embodiment, the system provides a broader access content that may be available to a user over a communications network (e.g. a local home network or the internet).

FIG. 5 is a block diagram of an exemplary controller 500 that implements the system described above with respect to FIGS. 1-4. The controller 500 may be a hardware component embodied in a set top box 102 as shown in FIG. 1. The controller 500 includes a tuner 510 that selectively receives and tunes an input signal 512. The input signal may be a television broadcast signal formatted in a particular signal format such as those set forth by the Motion Pictures Experts Group (MPEG) or any other signal format used for encoding and transmitting audiovisual data and ancillary data associated with the audiovisual data. The tuner 510 decodes any ancillary data accompanying the tuned input signal 512 and stores the decoded data in a memory 520. The ancillary data may include Electronic Program Guide (EPG) data or any other data encoded and transmitted with the input signal 512. A primary display device 505 is coupled to the tuner 510 for displaying at least one of the tuned input signal and ancillary data including EPG data included in the input signal.

The memory 520 includes at least one data structure, such as a database, that includes at least one user profile. The at least one user profile corresponds to a unique secondary display device 545 and includes information defining content that is interesting to the user. The user profile data may include a set of attributes used in describing program content. The attribute set may be predefined by the content provider (cable/satellite provider) and correspond to content characteristics that are transmitted along with the input signal that describe the various programs able to be tuned by tuner 510. In an alternative embodiment, the function of a database for the EPG function, may be located external to the controller 500. An external database (not shown), would interface with the content processor 525 via a suitable interface, such as a disc drive interface or a web interface for an external drive or cloud-based database respectively.

The controller 500 further includes an attribute processor 515 coupled to both the tuner 510 and the memory 520. In response to tuning a particular piece of content, the attribute processor 515 automatically parses the ancillary data to identify the attributes associated with each program listed in the ancillary data. In another embodiment, the attribute processor 515 is operable in response to user selection of content during program guide navigation. In a further embodiment, attribute processor 515 may be operable using data in the unique user profile to identify attributes associated with programs listed in the electronic program guide. In this embodiment, the attribute processor 515 automatically parses the electronic program guide at a set time in advance of the time frame in which the ancillary data will actually be displayed to a user. For example, if the ancillary data is electronic program guide data for a particular day, the attribute processor 515 may parse the electronic program guide at a predetermined time prior to the particular day. Alternatively, the parsing and populating may occur in response to receipt of a selection signal from a user.

In another embodiment, the system may automatically take into consideration user preferences and past user behavior data for use as input in order to search for content to be recommended to the user. The system may automatically track user behavior including user navigation and content selection data that can be stored with the user profile data in memory 520. The system can further access the user preference and navigation data to identify other potential types of content information and content sources that are displayed to the user on the secondary display device. By considering user preferences and behavior, the attribute processor 515 may automatically update the set of attributes in the data structure stored in memory 520 thereby enabling additional attribute data to be collected and used in searching for related content information. For example, the user-specified attributes may enable the system to prioritize an order of sources of related content information to be searched.

A content processor 525 is coupled to the tuner 510, attribute processor 515, a user interface (UI) display processor 540 and the memory 520. The content processor may execute a recommended content search algorithm such as those described above with respect to FIGS. 3 and 4. In one embodiment, in response to at least one of tuning a program or selecting a program during program guide navigation, the content processor 525 receives attribute data acquired by attribute processor 515 from the ancillary data. The content processor 525 executes a matching algorithm to match the set of attributes associated with the currently tuned (or selected) program with attributes of current and future programs listed in the ancillary data. If the matching algorithm determines that a match is present, the content processor 525 automatically identifies assigns a unique identifier to the program designating the program as recommended content. The content processor 525 determines if the matching program is currently available to be tuned by tuner 510 or available at a later time. Content processor 525 at least one of (a) initiates a recording of the program within memory 520 and (b) schedules a recording for when the program is available to be tuned by tuner 510. In another embodiment, the content processor 525 need not rely on attributes derived from a currently tuned or selected program. Rather, content processor 525 may automatically parse the user profile data and use the attribute data stored therein to initiate a search of ancillary data for content that may be of interest to the user.

The content processor 525 may also query the data structure in memory 520 to acquire attribute data which may be used to search additional sources for related content information and for sources where related content is stored. The attribute data may be used as search terms in the recommended content searching algorithm to locate information about each respective program assigned a unique program identifier. The content processor 525 initiates a search across at least one of a local and wide area network for information about the program. The recommended content information search algorithm may be included in the content search module which is executed by the content processor 525 engages an internet interface 530 which is coupled thereto to initiate a search of external data sources 535. Data representing the results of the search are retrieved by the content processor 525 and may be stored in memory 520. The search result data may be stored in a separate data structure from the attribute data and/or the user profile data but may be linked via the unique program identifiers so that the relevant data is quickly and easily retrieved when needed.

Content processor 525 may also automatically initiate a related content search algorithm which parses the search result data in the memory to search at least one external data source 535 for a source file of content corresponding to any data item listed in the search result data. As used herein, external data source 535 is a generic term used to denote any source of data for any purpose. For example, external data source 535 may be a source of content information (i.e. Wikipedia or IMDB.com) or a content provider (i.e. Netflix, Fancast.com). Upon performing the search for content, content processor 525 obtains the results including the location of the related content and content information. Content processor 525 automatically generates user-selectable links for any item for which location information has been obtained for the particular piece of content.

In one embodiment, during the search for recommended content, the content processor 525 may automatically take into account user subscription service information to determine if the content which may be identified as recommended is viewable by the user. For example, if the recommended content is determined to be located on a premium channel and the user's subscription does not allow access to the particular channel, the system may automatically append the particular recommended content data with a message telling the user that this content may be of interest but is unavailable due to content rights restrictions. Additionally, the message may also include information and/or a link enabling the user to modify service subscription so the recommended content can be viewed by the user. In another embodiment, if the ancillary data is searched and the content is not within a user's subscription level, the content processor 525 may engage the internet interface 530 to search external data sources including content providers to determine if the content is available from another source to which the user does have access. For example, if the content is located on an unavailable premium channel, the system may search HULU® or FANCAST® for the content and provide the source to the user on the secondary display device 545 in the form of a link viewable in a web browsing application.

Content processor 525 provides data representing the recommended content to a user interface (UI) display processor 540. UI display processor 540 automatically formats the recommended content according to a predetermined format and causes the recommended content to be displayed on a secondary display device 545 which is separate and different from a primary display device 505. The UI display processor 540 is responsive to a control signal generated by a user.

In one embodiment, the UI display processor 540 may provide the formatted user interface to the internet interface 530 which functions as a webserver and allows a browser executing on the secondary display device 545 to be pointed to a hosted user interface allowing user access thereto. Once presented on the secondary display device 545, a user may browse and navigate the data items on the list in order to view and/or select recommended content that interests them.

In another embodiment, the system may be embodied in a server responsible for serving a set of users. In this embodiment, the server executes the search algorithms described above to identify recommended content and provides users access to the recommended content to reduce the bandwidth and processing power needed to perform a full search of all of the possible content information and content provider sources. In response to selection of primary content, the set top box may automatically execute an application that initiates the content information and content provider search in the database of the server for recommended content thus reducing the amount of processing power, bandwidth and time required to provide the user with a set of enhanced content information.

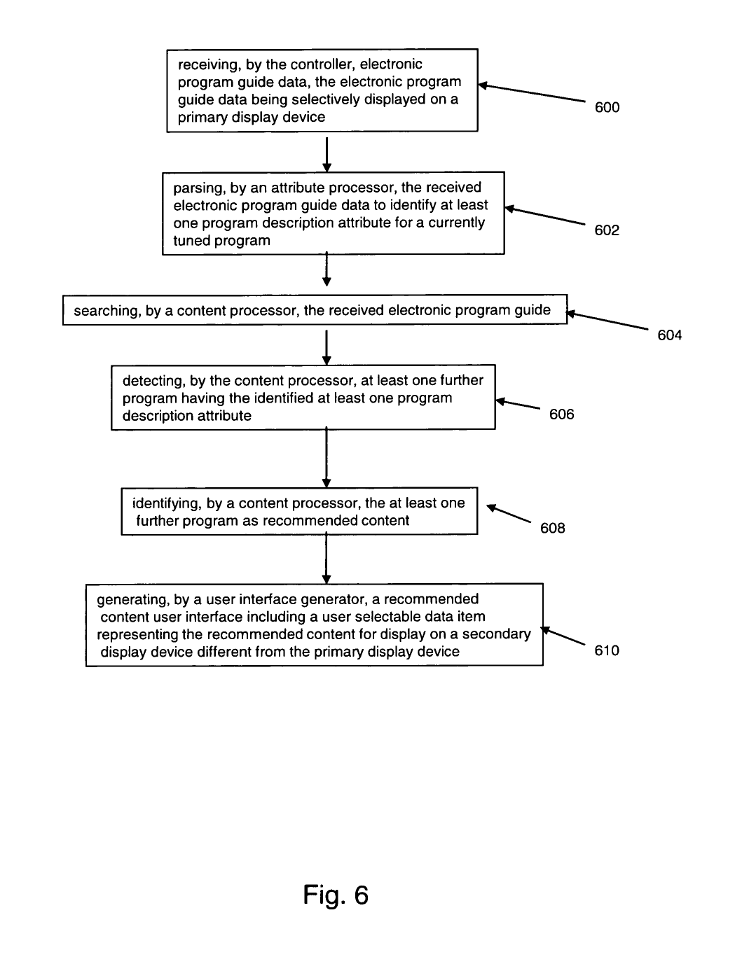

FIG. 6 is a flow diagram detailing an exemplary algorithm that controls the operation of the system described above. The system implements a method of identifying and providing content to a user. The method is performed by a controller with an internet interface. In step 600, a controller receives electronic program guide data, the electronic program guide data being selectively displayed on a primary display device. In step 602, an attribute processor parses the received electronic program guide data to identify at least one program description attribute for a currently tuned program. In step 604, a content processor searches the received electronic program guide and detects at least one further program having the identified at least one program description attribute in step 606. The content processor identifies the at least one further program as recommended content in step 608 and a user interface generator generates, a recommended content user interface including a user selectable data item representing the recommended content for display on a secondary display device different from the primary display device at step 610.

While the above description of identifying and acquiring related content is described for a broadcast television program, one skilled in the art may apply the principles of the system to any type of content that is available to a user. In an alternate embodiment, the system may tune a music station enabling a user to listen to a radio program. In this embodiment, the system identifies the content by parsing radio program guide information and, in order to acquire related content, may search content information sources other than Wikipedia, Google, and Fancast as described above. The system would then search content provider sources that are specific to the type of primary content being accessed by the user, for example internet radio broadcast sites, the iTunes store, etc. The techniques also apply to scenarios beyond television such as music playback and the location of related music in the user's music library, on a subscription service such as Rhapsody, or on a purchase site such as Amazon MP3 and the like.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims.

1. A method of identifying and providing content to a user, the method performed by a controller with an internet interface, the method comprising:
a. receiving, by the controller, electronic program guide data, the electronic program guide data being selectively displayed on a primary display device;
b. parsing, by an attribute processor, the received electronic program guide data to identify at least one program description attribute for a currently tuned program;
c. searching, by a content processor, the received electronic program guide;
d. detecting, by the content processor, at least one further program having the identified at least one program description attribute;
e. identifying, by a content processor, the at least one further program as recommended content; and
f. generating, by a user interface generator, a user interface display including the recommended content including a user selectable data item representing the recommended content for display on a secondary display device different from the primary display device.

2. The method of claim 1, further comprising:
searching, by the internet interface, an external source of content information associated with a currently tuned program to identify metadata describing the currently tuned program; and
using the identified metadata and the identified at least one program description attribute in searching the electronic program guide data for the at least one further program to be identified as recommended content data.

3. The method of claim 1, further comprising:
searching, by the internet interface, at least one content provider for the at least one further program identified as recommended content data;
acquiring location information associated with the recommended content identifying a location on a communications network at which the recommended content may be accessed; and
providing the recommended content data and the location information to the user interface display processor for inclusion in the recommended content user interface.

4. The method of claim 1, further comprising:
scrolling, via the controller, through a list of programs listed in the electronic program guide data; and
selecting, via the controller, a respective program in the list of programs by highlighting the respective program for a predetermined period of time; and
parsing, by an attribute processor, the received electronic program guide data to identify at least one program description attribute for a currently selected program;
searching, by a content processor, the received electronic program guide for at least one further program including the identified at least one program description attribute associated with the selected program and identified as recommended content; and
providing data representing the recommended content to the user interface display processor for including the recommended content in the recommended content user interface.

5. The method of claim 1, further comprising
storing the information identifying recommended content including the identified program that corresponds to the at least one program description attribute in a in a memory.

6. The method of claim 1, further comprising
generating user profile data including the at least one program description attribute; and
associating the user profile data with a secondary display device using a unique device identifier.

7. The method of claim 1, further comprising
automatically updating the user profile data with a plurality of program description attributes derived from at least one of (a) tuning a program different from the currently tuned program and (b) selecting a program as an active program during program guide navigation.

8. The method of claim 6, further comprising
parsing, by an attribute processor, the received electronic program guide data to identify at least one program description attribute that matches the user profile data;
searching, by a content processor, the received electronic program guide for at least one further program including the identified at least one program description attribute that matches the user profile data and identifying the at least one further program as recommended content; and
providing data representing the recommended content acquired using the user profile data to the user interface display processor for including the recommended content in the recommended content user interface.

9. A system that identifies and provides content to a user comprising:
a receiver that receives electronic program guide data, the electronic program guide data being selectively displayed on a primary display device;
an attribute processor that parses the received electronic program guide data to identify at least one program description attribute for a currently tuned program;
a content processor that searches the received electronic program guide for at least one further program including the identified at least one program description attribute and identifies the at least one further program as recommended content; and
a user interface generator that generates a recommended content user interface including a user selectable data item representing the recommended content for display on a secondary display device different from the primary display device.

10. The system of claim 9, further comprising:
an internet interface that searches an external source of content information associated with a currently tuned program to identify metadata describing the currently tuned program; and
said content processor uses the identified metadata and the identified at least one program description attribute to search the electronic program guide data for the at least one further program to be identified as recommended content data.

11. The system of claim 9, further comprising:
an internet interface that searches at least one content provider for the at least one further program to be identified as recommended content data; and
said content processor acquires location information associated with the recommended content, the location information identifying a location on a communications network at which the recommended content may be accessed and provides the recommended content data and the location information to the user interface display processor for inclusion in the recommended content user interface.

12. The system of claim 9, further comprising:
a controller that enables a user to scroll through a list of programs listed in the electronic program guide data and selects a respective program in the list of programs by highlighting the respective program for a predetermined period of time; wherein
said attribute processor parses the received electronic program guide data to identify at least one program description attribute for a currently selected program;
said content processor searches the received electronic program guide for at least one further program including the identified at least one program description attribute associated with the selected program and identified as recommended content; and provides data representing the recommended content to the user interface display processor for including the recommended content in the recommended content user interface.

13. The system of claim 9, further comprising
a memory that stores the information identifying recommended content including the identified program that corresponds to the at least one program description attribute.

14. The system of claim 9, wherein said content processor generates user profile data including the at least one program description attribute and associates the user profile data with a secondary display device using a unique device identifier.

15. The system of claim 14, wherein said content processor automatically updates the user profile data with a plurality of program description attributes derived from at least one of (a) tuning a program different from the currently tuned program and (b) selecting a program as an active program during program guide navigation.

16. The method of claim 14, wherein said attribute processor parses the received electronic program guide data to identify at least one program description attribute that matches the user profile data; and
said content processor:
searches the received electronic program guide for at least one further program including the identified at least one program description attribute that matches the user profile data and identifies the at least one further program as recommended content; and
provides data representing the recommended content acquired using the user profile data to the user interface display processor for including the recommended content in the recommended content user interface.
